(19) United States
(12) Patent Application Publication
(10) Pub. No.: US 2018/0260528 A1
(43) Pub. Date: Sep. 13, 2018

(54) INFORMATION PROCESSING APPARATUS, MEDICAL AUDIT APPARATUS, AND NON-TRANSITORY COMPUTER READABLE MEDIUM STORING PROGRAM

(71) Applicant: FUJI XEROX CO., LTD., Tokyo (JP)

(72) Inventor: Yosuke KOGURE, Kanagawa (JP)

(73) Assignee: FUJI XEROX CO., LTD., Tokyo (JP)

(21) Appl. No.: 15/792,759

(22) Filed: Oct. 25, 2017

(30) Foreign Application Priority Data
Mar. 10, 2017 (JP) 2017-046782

(51) Int. Cl. G06F 19/00; G06Q 10/06

(52) U.S. Cl. CPC G06F 19/327; G06F 19/3406; G06Q 50/24; G06Q 10/06311; G06F 19/325

(57) ABSTRACT

An information processing apparatus includes a memory that stores a medical act type and an execution record document type correlated with the medical act type in advance, and a holding unit that holds an execution record document which has, as an attribute thereof, a differing execution record document type which is different from the execution record document type correlated with the medical act type in advance and on which execution of a medical act having the medical act type as an attribute thereof is recorded, in correlation with the medical act.

### CROSS-REFERENCE TO RELATED APPLICATIONS

This application is based on and claims priority under 35 USC 119 from Japanese Patent Application No. 2017-046782 filed Mar. 10, 2017.

### BACKGROUND

### (i) Technical Field

The present invention relates to an information processing apparatus, a medical audit apparatus, and a non-transitory computer readable medium storing a program.

### (ii) Related Art

There is a system recording and preserving execution of a medical act on an execution record document having, as the attribute thereof, an execution record document type correlated in advance with a medical act type which is the type of the medical act.

### SUMMARY

According to an aspect of the invention, there is provided an information processing apparatus including a memory that stores a medical act type and an execution record document type correlated with the medical act type in advance; and a holding unit that holds an execution record document which has, as an attribute thereof, a differing execution record document type which is different from the execution record document type correlated with the medical act type in advance and on which execution of a medical act having the medical act type as an attribute thereof is recorded, in correlation with the medical act.

### BRIEF DESCRIPTION OF THE DRAWINGS

Exemplary embodiment(s) of the present invention will be described in detail based on the following figures, wherein:

FIG. 1 is a diagram illustrating an example of a medical information management system according to the present exemplary embodiment;

FIG. 2 is a diagram illustrating an example of a medical information management apparatus according to the present exemplary embodiment;

FIG. 3 is a diagram illustrating a terminal apparatus;

FIG. 4 is a diagram illustrating an example of a document type definition table;

FIG. 5 is a diagram illustrating an example of a document management table;

FIG. 6 is a diagram illustrating an example of a setting screen for correlating a medical act type with an execution record document type;

FIG. 7 is a diagram illustrating an example of a registration screen for an execution record document;

FIG. 8 is a diagram illustrating an example of a medical act execution progress screen;

FIG. 9 is a diagram illustrating an example of a document display screen;

FIG. 10 is a diagram illustrating an example of a document display screen;

FIG. 11 is a diagram illustrating an example of an execution record document registration screen; and

FIG. 12 is a diagram illustrating an example of an execution record document registration situation screen.

### DETAILED DESCRIPTION

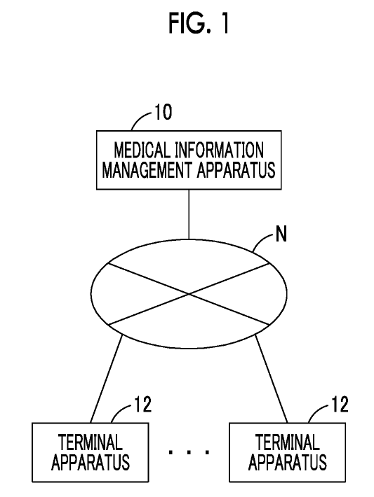

With reference to FIG. 1, a description will be made of a medical information management system as an information processing system according to an exemplary embodiment of the invention. FIG. 1 illustrates an example of a medical information management system according to the present exemplary embodiment.

The medical information management system according to the present exemplary embodiment is a system which registers and manages an execution record document on which execution of a medical act is recorded, and includes, for example, a medical information management apparatus 10 as an information processing apparatus, and one or plural of terminal apparatuses 12. The medical information management apparatus 10 and the terminal apparatus 12 have a function of performing communication with each other via a communication path N such as a network. The medical information management system may further include other apparatuses such as a server.

The medical information management apparatus 10 has a function of registering and managing an execution record document on which execution of a medical act is recorded. A registration instruction for the execution record document may be given by the medical information management apparatus 10, and may be given by the terminal apparatus 12. Data of the execution record document may be stored in the medical information management apparatus 10, may be transmitted to the terminal apparatus 12 so as to be stored in the terminal apparatus 12, and may be transmitted to other apparatuses such as a server so as to be stored in the other apparatuses. The execution record document may be displayed on the medical information management apparatus 10, the terminal apparatus 12, and other apparatuses.

The terminal apparatus 12 is an apparatus such as a personal computer (PC), a tablet PC, a smart phone, or a mobile phone.

Here, a description will be made of a medical act and an execution record document. The medical act is executed by a medical worker such as a doctor or a nurse, and is, for example, acts such as registration of a letter of introduction of a patient to another hospital, return for the letter of introduction, reporting of visit to the hospital of a patient, creation of hospitalization and medical care planning, surgery recording, and surgery part checking. In a hospital, in a case where a medical act is executed, execution of the medical act is typically recorded on an execution record document by a worker such as a medical worker. For example, execution of a medical act is recorded on an execution record document as a paper sheet, or is recorded on an execution record document by using data of the electronized execution record document. The execution record document is a document related to a medical act, and is, for example, a letter of return for a letter of introduction, a report of visit to the hospital, hospitalization and medical care plans, a surgery record document, and a surgery part check document.

In the present exemplary embodiment, a medical act type which is the attribute (for example, the type) of a medical act and an execution record document type which is the attribute (for example, the type) of an execution record document on which the medical act is to be recorded are correlated with each other in advance. Typically, in a case where a certain medical act (for example, “surgery recording”) is executed by a worker such as a medical worker, the execution of the medical act is recorded on an execution record document having, as the attribute thereof, an execution record document type (for example, a “surgery record document”) correlated in advance with a medical act type (for example, “surgery recording”) which is the attribute of the medical act. In the above-described example, a record of surgery is described on the surgery record document. For example, a worker such as a medical worker describes execution of a medical act on an execution record document as a paper sheet, or describes execution of a medical act on data of an execution record document.

On the other hand, there is a case where a certain medical act is recorded on an execution record document having, as the attribute thereof, an execution record document type which is different from an execution record document type correlated with a medical act type which is the attribute of the medical act in advance. For example, there is a case where execution of a medical act such as “surgery part checking” is recorded on an execution record document having, as the attribute thereof, an execution record document type (for example, a “surgery record document”) which is different from an execution record document type (for example, a “surgery part check document”) correlated in advance with a medical act type (for example, “surgery part checking”) which is the attribute of the medical act. In other words, there is a case where execution of a medical act such as “surgery part checking” is originally to be recorded on a “surgery part check document” but is recorded on a “surgery record document” which is different from the “surgery part check document” along with execution of a medical act such as “surgery recording”. For example, it is assumed that a medical worker execution of medical acts such as “surgery recording” and “surgery part checking” is recorded on a single “surgery record document”. In this case, an execution record document (for example, a “surgery part check document”) having, as the attribute thereof, an execution record document type correlated in advance with a medical act type such as “surgery part checking” does not exist in terms of the entity thereof.

In the above case, in the present exemplary embodiment, the medical information management apparatus 10 holds an execution record document (“surgery record document”) on which execution of a medical act having the medical act type (for example, “surgery part checking”) as the attribute thereof is recorded, in correlation with the medical act (“surgery part checking”). The execution record document (for example, a “surgery record document”) is used as an execution record document (for example, a “surgery record document”) on which execution of a medical act having, as the attribute thereof, a medical act type (for example, “surgery recording”) correlated with an execution record document type in advance as the attribute of the execution record document is recorded, and is also used as an execution record document (for example, a “surgery part check document”) on which execution of a medical act having, as the attribute thereof, another medical act type (for example, “surgery part checking”) correlated in advance with an execution record document type which is different from the execution record document type is recorded. In other words, the execution record document is used as a substitute execution record document of the execution record document having an execution record document type correlated with another medical act type in advance as the attribute thereof.

As mentioned above, in a medical site, there are cases where execution of all medical acts is not recorded on regular execution record documents (execution record documents having, as the attributes thereof, execution record document types correlated in advance with medical act types as the attributes of the medical acts) on which the medical acts are originally to be recorded, and execution of at least some of the medical acts is recorded on execution record documents having, as the attributes thereof, execution record document types correlated in advance with other medical act types.

An execution record document is used for medical audits. In the audits, for example, an audit for evaluating whether or not a medical act has been appropriately executed, an audit for evaluating whether or not a predefined medical act has been actually executed, and an audit for evaluating whether or not respective medical acts have been executed in a predefined order are performed. The audits are performed by, for example, an auditor. For example, in a case where the entity (for example, a paper sheet or data) of an execution record document on which execution of a certain medical act is recorded exists, it is determined that the medical act has been actually executed. As mentioned above, there is a case where it is proved that a medical act has been appropriately executed by the existence of the entity of an execution record document. During an audit, for example, information indicating the existence or absence of the entity of an execution record document or the execution record document is displayed on a display device, and an auditor performs the audit on the basis of information displayed thereon. An audit may be performed on an audit performed by the auditor in order to evaluate whether or not the audit has been appropriately performed. Also in this case, the audit may be performed by checking the existence or absence of the entity of an execution record document.

Hereinafter, a description will be made of each apparatus included in the medical information management system according to the present exemplary embodiment.

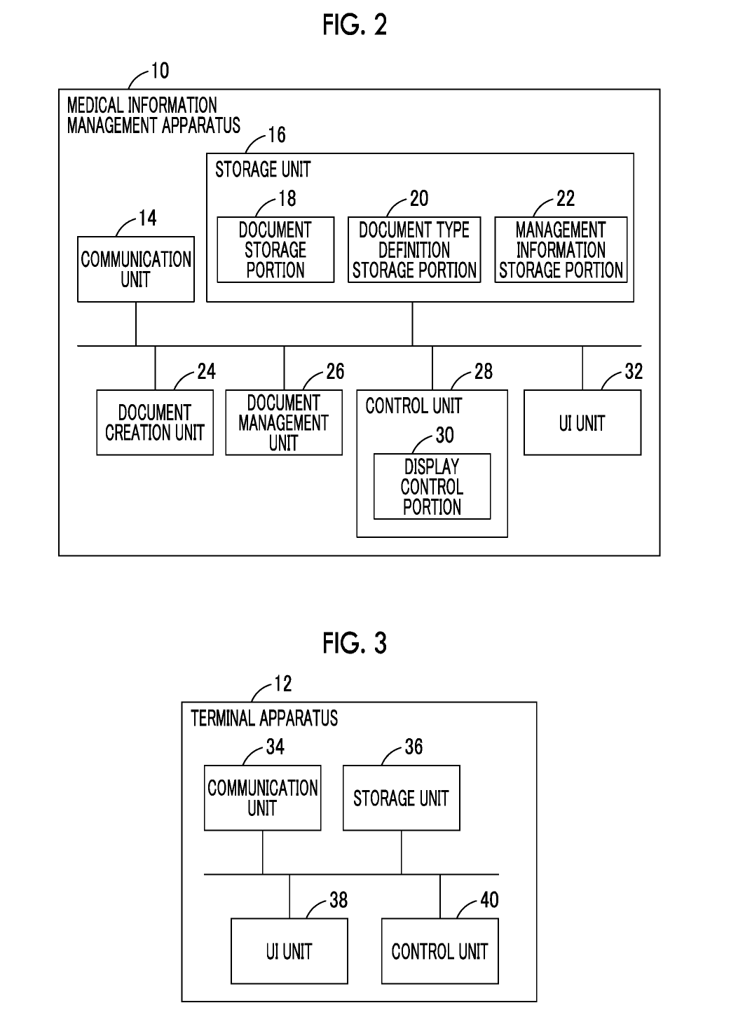

With reference to FIG. 2, the medical information management apparatus 10 will be described in detail. FIG. 2 illustrates a configuration of the medical information management apparatus 10.

A communication unit 14 is a communication interface, and has a function of transmitting data to other apparatuses and a function of receiving data from other apparatuses. The communication unit 14 may be a communication interface having a wireless communication function, and may be a communication interface having a wired communication function.

A storage unit 16 is a storage device such as a hard disk or a memory, and stores various programs, various pieces of data, address information (for example, address information of the terminal apparatus 12) of external apparatuses, and the like. The storage unit 16 includes a document storage portion 18, a document type definition storage portion 20, and a management information storage portion 22.

The document storage portion 18 stores data of an execution record document (data as the entity of the execution record document) on which execution of a medical act is executed. The data of the execution record document is created by a document creation unit 24 which will be described later. The data of the execution record document may not be stored in the document storage portion 18 and may be stored in other storage devices (for example, a server).

The document type definition storage portion 20 stores document type definition information. The document type definition information is information indicating a correlation among a medical act type which is the attribute of a medical act, an execution record document type which is the attribute of an execution record document to which execution of the medical act is to be recorded, and a substitute execution record document type as the attribute of a substitute execution record document expected to be used as a substitute document of the execution record document. For example, the document type definition information is created in advance, and is stored in the document type definition storage portion 20.

The management information storage portion 22 stores management information for managing an execution record document. The management information is, for example, information indicating a correlation among patient identification information (for example, a patient name or a patient ID) for identifying a patient, a medical act (or a medical act type as the attribute of the medical act) executed regarding the patient, and an execution record document (or an execution record document type as the attribute of the execution record document) on which execution of the medical act is recorded. A medical act whose execution is recorded on a substitute execution record document is correlated with an execution record document (or an execution record document type) having, as the attribute thereof, the execution record document type correlated in advance with a medical act type as the attribute of the medical act, and is also correlated with the substitute execution record document (or a substitute execution record document type as the attribute of the substitute execution record document). A medical act whose execution is not recorded on a substitute execution record document is not correlated with the substitute execution record document (or a substitute execution record document type). A medical act whose execution is recorded on a substitute execution record document and an execution record document for which the substitute execution record document is substituted are specified by referring to the management information. The management information may include, as information other than the information, document identification information for identifying data of an execution record document, information indicating a location where the data of the execution record document is stored (for example, address information such as URL indicating a storage location of the data), and the like. For example, the management information is updated when an execution record document is registered in the medical information management system. Of course, the management information may be edited by a worker.

The document creation unit 24 has a function of creating data of an execution record document. The data of the execution record document is stored in the document storage portion 18. For example, an execution record document as a paper sheet on which execution of a medical act is described is read with a scanner, and the document creation unit 24 creates data (for example, image data) of the execution record document on the basis of a result of the reading. For example, patient identification information (for example, a patient name or a patient ID) for identifying a patient or information indicating an execution record document type of an execution record document is described as code information (for example, a one-dimensional barcode or a two-dimensional barcode) on the execution record document as a paper sheet. If the execution record document as a paper sheet is read with a scanner, the code information is read. The document creation unit 24 acquires the patient identification information or the information indicating the execution record document type by analyzing the code information, and correlates the information with data of the execution record document as management information of the execution record document. The management information is stored in the management information storage portion 22. Of course, the data of the execution record document may be used without using the execution record document as a paper sheet. The document creation unit 24 may acquire patient identification information or information indicating an execution record document type without using the code information. For example, patient identification information may be input by a worker, and may be input to the medical information management apparatus 10 from another apparatus.

A document management unit 26 has a function of performing processes such as registration, update, and reference of an execution record document. For example, when an execution record document is registered, the document management unit 26 stores management information of an execution record document on which execution of a medical act is recorded, in the management information storage portion 22. Consequently, the execution record document is registered in the medical information management system. The document management unit 26 stores data as the entity of the execution record document on which execution of the medical act is recorded, in the document storage portion 18. In a case where an instruction for editing management information is received, the document management unit 26 edits the management information. For example, in a case where an instruction for changing a correlation among respective pieces of information included in the management information is received after the execution record document is registered, the document management unit 26 edits the management information in response to the instruction.

Hereinafter, an execution record document whose data or a paper sheet as the entity thereof exists and which has been registered will be referred to as an “entity registered document (registered document)”, and this registration will be referred to as “entity registration”. For example, in a case where data as the entity of an execution record document exists, and is stored in the document storage portion 18, and management information of the execution record document is stored in the management information storage portion 22, the execution record document is regarded to be registered in the medical information management system, and the execution record document corresponds to an entity registered document.

In a case where execution of a medical act is recorded on an execution record document (substitute execution record document) having, as the attribute thereof, an execution record document type which is different from an execution record document type correlated in advance with a medical act type as the attribute of the medical act, the document management unit 26 registers a substitute execution record document in correlation with the medical act. The document management unit 26 stores management information of the execution record document (the execution record document having, as the attribute thereof, the execution record document type correlated with the medical act type in advance) for which the substitute execution record document is substituted in the management information storage portion 22, so as to register the execution record document for which the substitute execution record document is substituted. The substitute execution record document is an entity registered document in which data or a paper sheet as an entity exists, and data as the entity of the substitute execution record document is stored in the document storage portion 18. On the other hand, data or a paper sheet as the entity of the execution record document for which the substitute execution record document is subsisted does not exist, and the data is not stored in the document storage portion 18. Hereinafter, an execution record document registered without existence of data or a paper sheet as the entity thereof will be referred to as a “deemed registered document”, and this registration will be referred to as “deemed registration”. In management information of the deemed registered document, a medical act whose execution is recorded on a substitute execution record document, an execution record document (or an execution record document type) (that is, a deemed registered document or the attribute thereof) having, as the attribute thereof, the execution record document type correlated in advance with a medical act type as the attribute of the medical act, and the substitute execution record document (or a substitute execution record document type as the attribute of the substitute execution record document) are correlated with each other.

A control unit 28 has a function of controlling an operation of each unit of the medical information management apparatus 10. The control unit 28 includes a display control portion 30.

The display control portion 30 has a function of controlling display of an execution record document or other information. The display control portion 30 may display, for example, an execution record document or a registration screen for an execution record document on a user interface unit (UI unit) 32 of the medical information management apparatus 10 or the terminal apparatus 12.

The UI unit 32 is a user interface unit, and includes a display portion and an operation portion. The display portion is a display device such as a liquid crystal display. The operation portion is an input device such as a touch panel or a keyboard. Of course, the UI unit 32 may be a user interface (for example, a touch display) used as both of the display portion and the operation portion. The medical information management apparatus 10 may not include the UI unit 32.

Hereinafter, with reference to FIG. 3, the terminal apparatus 12 will be described in detail. FIG. 3 illustrates a configuration of the terminal apparatus 12.

A communication unit 34 is a communication interface, and has a function of transmitting data to other apparatuses and a function of receiving data from other apparatuses. The communication unit 34 may be a communication interface having a wireless communication function, and may be a communication interface having a wired communication function.

A memory 36 is a storage device such as a hard disk or a memory, and stores various programs, various pieces of data, address information (for example, address information of the medical information management apparatus 10) of external apparatuses, and the like.

A UI unit 38 is a user interface unit, and includes a display portion and an operation portion. The display portion is a display device such as a liquid crystal display. The operation portion is an input device such as a touch panel or a keyboard. Of course, the UI unit 38 may be a user interface (for example, a touch display) used as both of the display portion and the operation portion.

A control unit 40 has a function of controlling an operation of each unit of the terminal apparatus 12. The control unit 40 functions as, for example, a display controller, and displays various pieces of information on the UI unit 38.

The terminal apparatus 12 is used to register or refer to an execution record document, for example. For example, when an execution record document is registered, a registration screen for the execution record document is displayed on the UI unit 38 of the terminal apparatus 12, and a worker such as a medical worker performs an operation of registering the execution record document by using the terminal apparatus 12. Of course, a registration operation may be performed by using the medical information management apparatus 10 without using the terminal apparatus 12.

The terminal apparatus 12 may include the document creation unit 24 or the document management unit 26, and may perform processes of creating or registering data of an execution record document. The terminal apparatus 12 may include the document storage portion 18, the document type definition storage portion 20, or the management information storage portion 22, and may store data of an execution record document, store document type definition information, or store management information.

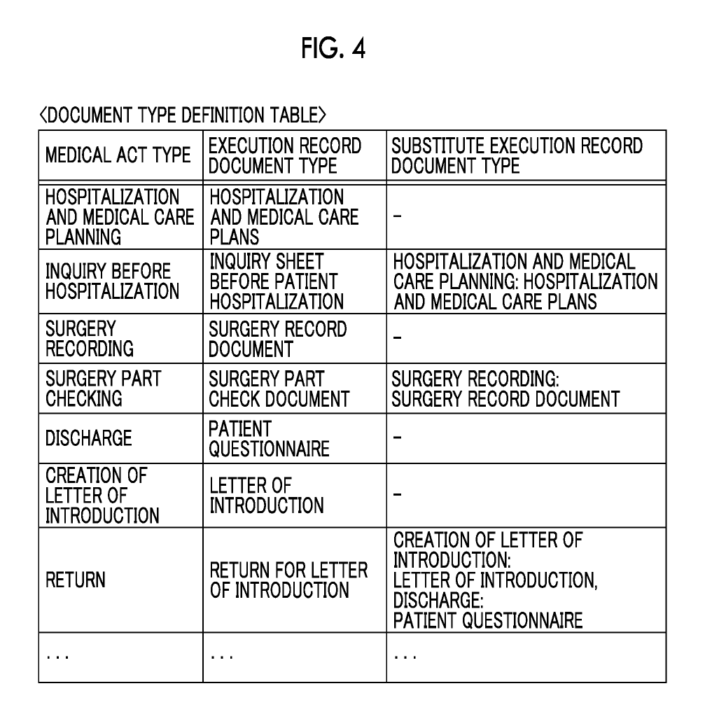

Hereinafter, with reference to FIG. 4, document type definition information will be described in detail. FIG. 4 illustrates an example of a document type definition table as document type definition information. Data of the document type definition table is created in advance, and is stored in the document type definition storage portion 20.

In the document type definition table, for example, information indicating a medical act type, information indicating an execution record document type as the attribute of an execution record document on which execution of a medical act having the medical act type as the attribute thereof is to be recorded, and information indicating a substitute execution record document type as the attribute of a substitute execution record document used as a substitute document of the execution record document are correlated with each other. There is a case where not only a medical act originally to be recorded but also execution of a medical act to be recorded on an execution record document for which a substitute execution record document is substituted is recorded on the substitute execution record document having a substitute execution record document type as the attribute thereof.

For example, a medical act type such as “surgery recording” and an execution record document type such as a “surgery record document” are correlated with each other. A medical act having a medical act type such as “surgery recording” as the attribute thereof is a medical act to be recorded on an execution record document having an execution record document type such as a “surgery record document” as the attribute thereof. In other words, the execution record document having an execution record document type such as a “surgery record document” as the attribute thereof is a document on which a medical act having a medical act type such as “surgery recording” as the attribute thereof is recorded.

A medical act type such as “surgery part checking”, an execution record document type such as a “surgery part check document”, and a substitute execution record document type such as a “surgery record document” are correlated with each other. A medical act having a medical act type such as “surgery part checking” as the attribute thereof is a medical act to be recorded on an execution record document having an execution record document type such as a “surgery part check document” as the attribute thereof. In other words, the execution record document having an execution record document type such as a “surgery part check document” as the attribute thereof is a document on which a medical act having a medical act type such as “surgery part checking” as the attribute thereof is recorded. There is a case where a medical act having a medical act type such as “surgery part checking” as the attribute thereof is recorded on an execution record document (substitute execution record document) having an execution record document type (substitute execution record document type) such as a “surgery record document” as the attribute thereof. In other words, there is a case where an execution record document having an execution record document type such as a “surgery part check document” as the attribute thereof is replaced with an execution record document having an execution record document type such as a “surgery record document” as the attribute thereof. In other words, there is a case where execution of a medical act having a medical act type such as “surgery recording” as the attribute thereof and execution of a medical act having a medical act type such as “surgery part checking” as the attribute thereof are recorded on an execution record document having an execution record document type such as a “surgery part check document” as the attribute thereof. In this case, the execution record document having an execution record document type such as a “surgery record document” as the attribute thereof corresponds to a substitute execution record document of the execution record document having an execution record document type such as a “surgery part check document” as the attribute thereof.

A medical act type and an execution record document type may be correlated with one or plural substitute execution record document types. In the example illustrated in FIG. 4, an execution record document type such as “return for a letter of introduction” is correlated with plural substitute execution record document types (a “letter of introduction” and a “patient QUESTIONNAIRE”).

A worker may correlate a medical act type, an execution record document type, and a substitute execution record document type with each other through a manual operation, and the document management unit 26 may automatically perform the correlating operation. The document management unit 26 may correlate a substitute execution record document type (for example, a substitute execution record document type whose relevance with a medical act type is equal to or more than a predefined threshold value) having relevance with a medical act type with the medical act type on the basis of, for example, the actual history or statistical materials of medical act execution records.

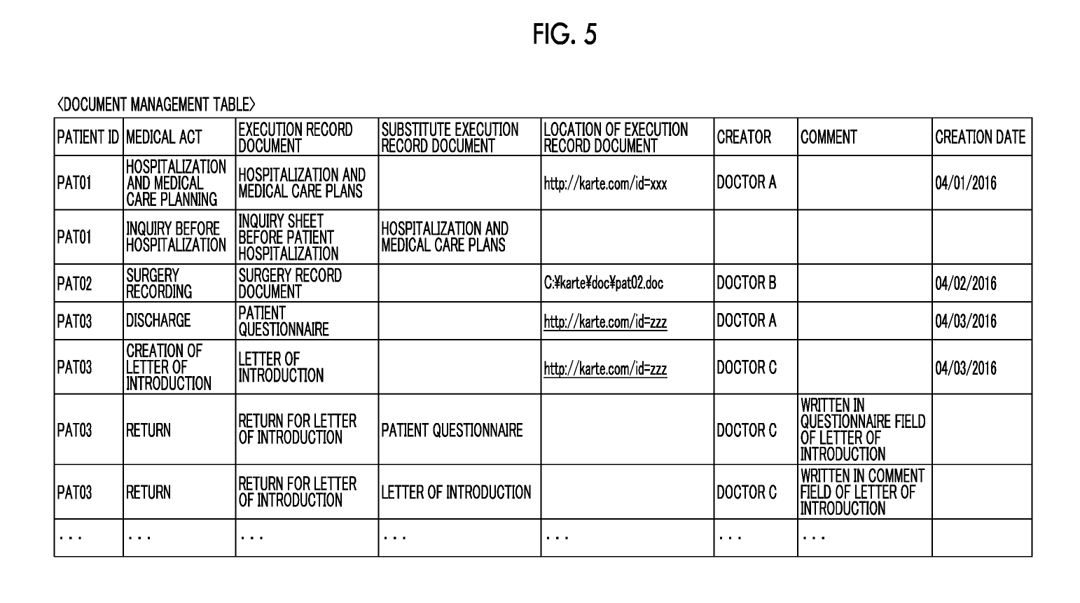

Hereinafter, with reference to FIG. 5, management information will be described in detail. FIG. 5 illustrates an example of a document management table as management information. Data of the document management table is stored in the management information storage portion 22.

In the document management table, for example, a patient ID as patient identification information, information indicating a medical act (or information indicating a medical act type), information indicating an execution record document (or information indicating an execution record document type), information indicating a substitute execution record document (or information indicating a substitute execution record document type), information indicating a location of the execution record document, information indicating a creator of the execution record document, information indicating a comment on document creation, and information indicating the creation date of the execution record document are correlated with each other.

The information indicating a medical act is information indicating a medical act executed on a patient having a patient ID correlated with the information indicating the medical act. The information indicating an execution record document is information indicating an execution record document having, as the attribute thereof, an execution record document type correlated in advance with a medical act type as the attribute of the medical act. The information indicating a substitute execution record document is information correlated in a case where execution of the medical act is recorded on the substitute execution record document, and is information indicating an execution record document on which execution of the medical act is actually recorded. The information indicating a location of the execution record document is information indicating a storage location (for example, address information such as URL) of data of the execution record document.

Execution of a medical act not correlated with a substitute execution record document is recorded on an execution record document correlated in advance with the medical act, data or a paper sheet as the entity of the execution record document exists, and the execution record document is registered in the medical information management system. For example, data as the entity of the execution record document exists, and is stored in the document storage portion 18. The execution record document corresponds to an “entity registered document”.

Execution of a medical act correlated with a substitute execution record document is not recorded on an execution record document correlated in advance with the medical act, and is recorded on the substitute execution record document. Data or a paper sheet as the entity of the execution record document does not exist, data or a paper sheet as the entity of the substitute execution record document, and the execution record document is deemed to be registered in the medical information management system. The execution record document corresponds to a “deemed registered document”.

A description will be made by using a specific example. A medical act having a medical act type such as “hospitalization and medical care planning” as the attribute thereof is executed on a patient having a patient ID “PAT01”. The medical act is not correlated with a substitute execution record document, and execution of the medical act is recorded on an execution record document having an execution record document type such as “hospitalization and medical care plans” correlated in advance with the medical act type as the attribute thereof. Data or a paper sheet as the entity of the execution record document exists, for example, the data is stored in the document storage portion 18, and management information of the execution record document is registered in the document management table. In other words, the execution record document having an execution record document type such as “hospitalization and medical care plans” as the attribute thereof corresponds to an “entity registered document” whose entity is registered.

A medical act having a medical act type such as “inquiry before hospitalization” as the attribute thereof is executed on the patient having the patient ID “PAT01”. The medical act is correlated with a substitute execution record document, and execution of the medical act is not recorded on an execution record document having, as the attribute thereof, an execution record document type such as an “inquiry sheet before patient hospitalization” correlated in advance with the medical act type, and is recorded on an execution record document having a substitute execution record document type such as “hospitalization and medical care plans” as the attribute thereof. In other words, both execution of the medical act having a medical act type such as “hospitalization and medical care planning” as the attribute thereof and execution of the medical act having a medical act type such as “inquiry before hospitalization” as the attribute thereof are recorded on the execution record document having an execution record document type such as “hospitalization and medical care plans” as the attribute thereof. Data or a paper sheet as the entity of the execution record document type such as an “inquiry sheet before patient hospitalization” as the attribute thereof does not exist, data or a paper sheet as the entity of the substitute execution record document having a substitute execution record document type such as “hospitalization and medical care plans” as the attribute thereof exists, for example, the data is stored in the document storage portion 18, and management information of the execution record document having an execution record document type such as an “inquiry sheet before patient hospitalization” as the attribute thereof is recorded in the document management table. In other words, the execution record document having an execution record document type such as an “inquiry sheet before patient hospitalization” as the attribute thereof is a document deemed to be registered in the medical information management system, and corresponds to a “deemed registered document” whose entity is not registered.

A document on which execution of a medical act is recorded is specified by referring to the document management table. An execution record document which is deemed to be registered is specified. A medical act not correlated with a substitute execution record document is recorded on an execution record document (an execution record document on which the medical act is originally to be recorded) having, as the attribute thereof, an execution record document type correlated in advance with a medical act type as the attribute of the medical act. An execution record document not correlated with a substitute execution record document corresponds to an entity registered document (for example, a document whose data is stored in the document storage portion 18) in which data or a paper sheet as the entity thereof exists. On the other hand, a medical act correlated with a substitute execution record document is not recorded on an execution record document having, as the attribute thereof, an execution record document type correlated in advance with a medical act type as the attribute of the medical act, and is recorded on the substitute execution record document. The execution record document correlated with the substitute execution record document is a deemed registered document in which data or a paper sheet as the entity thereof does not exist.

For example, if a registration instruction for an execution record document is given from a worker, the document management unit 26 adds management information of the execution record document to the document management table so as to update the document management table. An execution record document in which data or a paper sheet as the entity thereof exists is registered as a document having an entity. An execution record document in which data as the entity thereof does not exist is deemed to be registered.

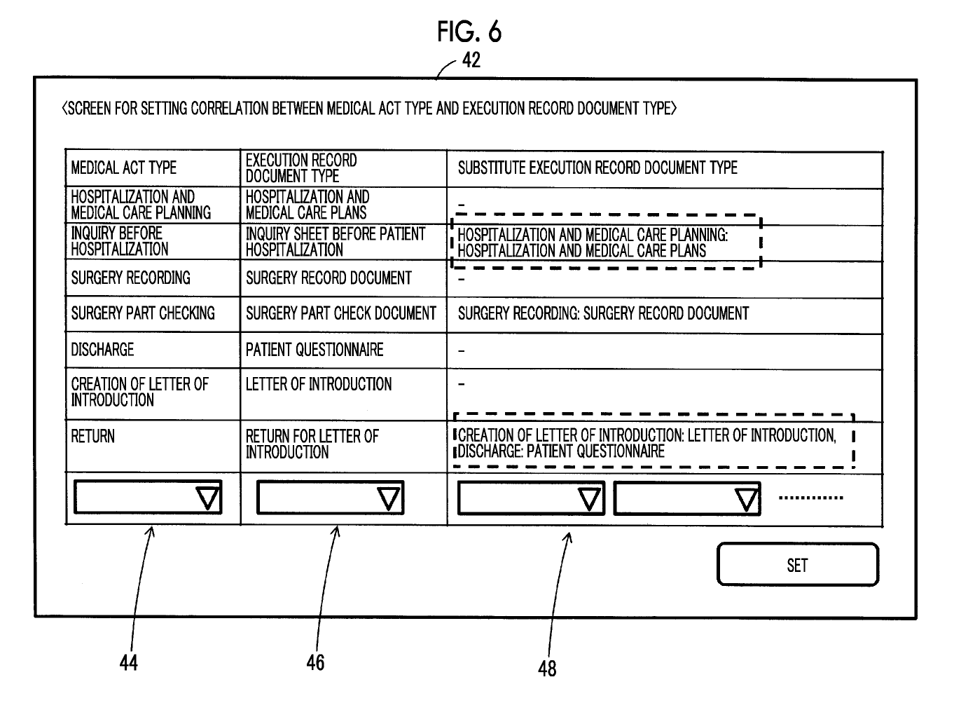

Hereinafter, with reference to FIG. 6, a detailed description will be made of a setting screen for correlating a medical act type with an execution record document type. FIG. 6 illustrates an example of the setting screen.

For example, it is assumed that a worker performs a correlating operation by using the terminal apparatus 12. In this case, if the worker accesses the medical information management apparatus 10 by using the terminal apparatus 12, and makes a request for a correlation between a medical act type and an execution record document type, data of a setting screen 42 for performing the correlation is transmitted from the medical information management apparatus 10 to the terminal apparatus 12, and the setting screen 42 is displayed on the UI unit 38 of the terminal apparatus 12. Of course, the worker may perform a correlating operation by using the UI unit 32 of the medical information management apparatus 10. In this case, the setting screen 42 is displayed on the UI unit 32 of the medical information management apparatus 10.

The setting screen 42 is a screen for setting information included in the document type definition table, and includes, specifically, a medical act type entry field 44, an execution record document type entry field 46, and a substitute execution record document type entry field 48. Information indicating a medical act type is entered to the medical act type entry field 44. Information indicating an execution record document type as the attribute of an execution record document on which execution of the medical act having the medical act type as the attribute thereof is to be recorded is entered to the execution record document type entry field 46. Information indicating a substitute execution record document type as the attribute of a substitute execution record document used as a substitute document of the execution record document is entered to the substitute execution record document type entry field 48. Information indicating a substitute execution record document type is not entered with respect to a medical act for which a substitute execution record document is not used.

In the example illustrated in FIG. 6, each entry field has a pull-down form, and, if the worker designates each entry field, a list of medical act type candidates is displayed in the medical act type entry field 44, a list of execution record document type candidates is displayed in the execution record document type entry field 46, and a list of substitute execution record document type candidates is displayed in the substitute execution record document type entry field 48. The worker designates a medical act type, an execution record document type, and a substitute execution record document type from the lists. Of course, the worker may enter text so as to designate a medical act type, an execution record document type, and a substitute execution record document type.

A setting button image is displayed on the setting screen 42, and, if the worker presses the setting button image, the document management unit 26 creates a document type definition table by correlating information indicating the medical act type entered to the medical act type entry field 44, information indicating the execution record document type entered to the execution record document type entry field 46, and information indicating the substitute execution record document type entered to the substitute execution record document type entry field 48 with each other. One or plural substitute execution record document types may be designated, and information indicating the one or plural substitute execution record document types may be correlated with information indicating a medical act type and information indicating an execution record document type.

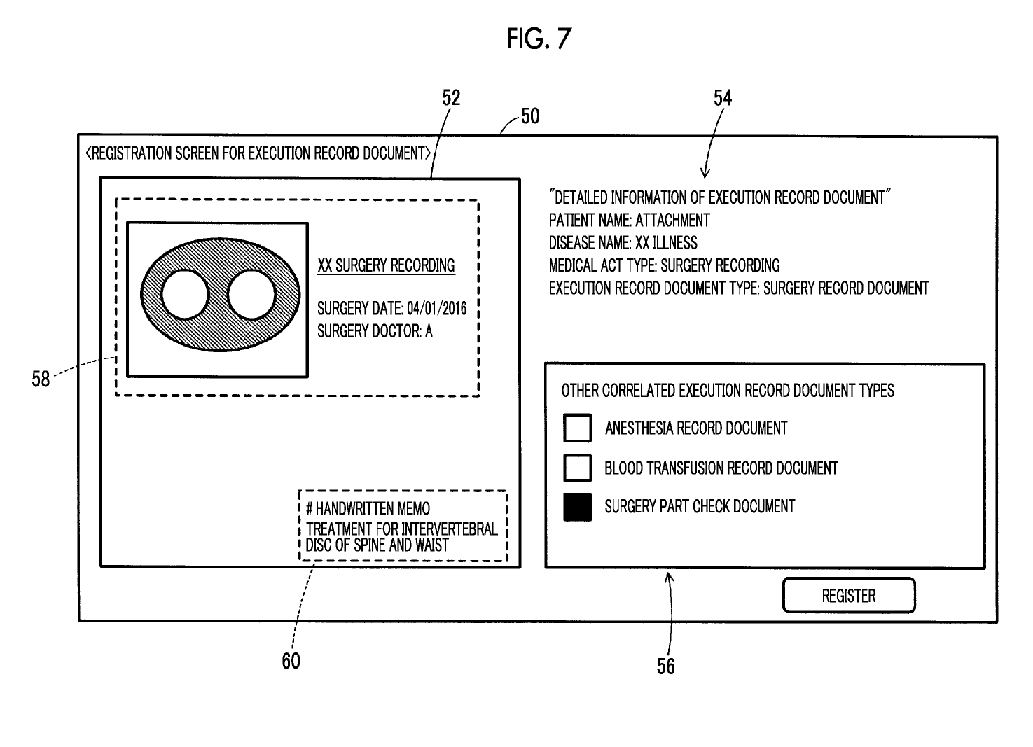

Hereinafter, with reference to FIG. 7, a description will be made of a process performed in a case where an execution record document is registered. FIG. 7 illustrates an example of a registration screen for an execution record document.

For example, it is assumed that a worker performs an operation of registering an execution record document by using the terminal apparatus 12. In this case, if the worker accesses the medical information management apparatus 10 by using the terminal apparatus 12, and makes a request for registering an execution record document, data of a registration screen 50 is transmitted from the medical information management apparatus 10 to the terminal apparatus 12, and thus the registration screen 50 is displayed on the UI unit 38 of the terminal apparatus 12. Of course, the worker may perform an operation of registering an execution record document by using the medical information management apparatus 10. In this case, the registration screen 50 is displayed on the UI unit 32 of the medical information management apparatus 10. Hereinafter, it is assumed that a registration operation is performed by using the terminal apparatus 12.

The registration screen 50 includes, for example, a document display region 52, a detailed information display region 54, and an execution record document type selection field 56.

An execution record document as a registration target is displayed in the document display region 52. For example, in a case where an execution record document as a paper sheet is registered, if the execution record document is read with a scanner, the document creation unit 24 creates data (for example, image data or text data) as the entity of the execution record document on the basis of a reading result. An image or text of the execution record document created through the reading is displayed in the document display region 52. In a case where an electronized execution record document is used, data thereof is registered.

Patient identification information or information indicating an execution record document type as the attribute of the execution record document is described in the execution record document as code information. The code information is also read by reading the execution record document with the scanner, and thus document creation unit 24 acquires the patient identification information or the information indicating the execution record document type by analyzing the code information. Patient identification information or information indicating an execution record document type is displayed in the detailed information display region 54. In a case where an electronized execution record document is used, data of the execution record document is correlated with the patient identification information or the information indicating the execution record document as accessory information, and the patient identification information or the like included in the accessory information is displayed in the detailed information display region 54.

In the example illustrated in FIG. 7, a registration operation for an execution record document (“surgery record document”) having an execution record document type such as a “surgery record document” is performed. The surgery record document is displayed in the document display region 52. In the surgery record document, execution of a medical act having, as the attribute thereof, a medical act type such as “surgery recording” correlated in advance with an execution record document type such as a “surgery record document” is recorded in the region 58, and execution of a medical act having, as the attribute thereof, a medical act type (for example, “surgery part checking”) which is different from the medical act type such as “surgery recording” is recorded in the region 60. For example, a result of surgery part checking is described as a memo handwritten by a doctor. Patient information, information indicating (for example, a “surgery record document”) indicating an execution record document type as the attribute of an execution record document which is a registration target, information (for example, “surgery recording”) indicating a medical act type correlated with the execution record document type in advance, and the like are displayed in the detailed information display region 54.

A list of candidates of an execution record document type as the attribute of a deemed registered document is displayed in the execution record document type selection field 56. Specifically, as the list of the candidates, a list of candidates of an execution record document type which is different from an execution record document type as the attribute of a registration target execution record document and of an execution record document type correlated with the registration target execution record document. In a case where a registration instruction for a registration target execution record document is given, the document management unit 26 registers the registration target execution record document in the medical information management system, correlates an execution record document type selected from the list of the candidates with the registration target execution record document, and deems an execution record document having the selected execution record document type as the attribute thereof to be registered. In this case, the registration target execution record document is registered as an execution record document having an execution record document type thereof as the attribute thereof, and is also registered as a substitute execution record document of an execution record document having an execution record document type selected from the list as the attribute thereof.

All execution record document types may be displayed in the execution record document type selection field 56, and a predefined execution record document type may be displayed therein. For example, in the document type definition table, an execution record document type with which an execution record document type as the attribute of a registration target execution record document is correlated as a substitute execution record document type may be displayed in the execution record document type selection field 56. As another example, an execution record document type selected on the basis of the actual history or statistical materials of medical act execution records may be displayed in the execution record document type selection field 56.

In the example illustrated in FIG. 7, as candidates of other execution record document types correlated with the registration target execution record document, pieces of information respectively indicating an “anesthesia record document”, a “blood transfusion record document”, and a “surgery part check document” are displayed. For example, in the document type definition table, in a case where an execution record document type such as a “surgery record document” is correlated with an execution record document type such as an “anesthesia record document” as a substitute execution record document type, the execution record document type such as an “anesthesia record document” is displayed as a candidate in the execution record document type selection field 56 of the registration screen 50 for registering an execution record document having the execution record document type such as a “surgery record document” as the attribute thereof. This is also the same for the “blood transfusion record document” and the “surgery part check document”.

In a case where a worker checks the content of the registration target execution record document, and execution of a medical act having, as the attribute thereof, a medical act type which is different from a medical act type correlated in advance with an execution record document type as the attribute of the execution record document is recorded on the execution record document, the worker selects an execution record document type correlated in advance with the differing medical act type from the list displayed in the execution record document type selection field 56. In the example illustrated in FIG. 7, execution of a medical act having a medical act type such as “surgery part checking” as the attribute thereof is recorded on the registration target execution record document, and an execution record document type such as a “surgery part check document” is selected in the execution record document type selection field 56 by the worker.

In a case where a registration button image is displayed on the registration screen 50, and the worker presses the registration button image, the document management unit 26 adds management information of the registration target execution record document to the document management table illustrated in FIG. 5. The document management unit 26 stores data of the registration target execution record document in the document storage portion 18. Consequently, the registration target execution record document (an execution record document in which data or a paper sheet as the entity thereof exists) is registered (entity-registered) in the medical information management system.

In a case where an execution record document type is selected from the list of the candidates displayed in the execution record document type selection field 56, the document management unit 26 correlates the selected execution record document type (that is, a medical act type correlated with the selected execution record document type in advance, or a medical act having the medical act type as the attribute thereof) with the registration target execution record document as a substitute execution record document, and deems an execution record document having the selected execution record document type as the attribute thereof to be registered in the medical information management system as a deemed registered document. In other words, the document management unit 26 causes information indicating the substitute execution record document to be included in management information of the deemed registered target execution record document, and registers the management information in the document management table. Specifically, an execution record document having, as the attribute thereof, an execution record document type selected from the list in the execution record document type selection field 56, a medical act having, as the attribute thereof, a medical act type correlated in advance with the execution record document type, and a substitute execution record document are correlated with each other, and are added to the document management table as management information. Consequently, the execution record document having, as the attribute thereof, the execution record document type selected from the list in the execution record document type selection field 56 is deemed to be registered in the medical information management system as a deemed registered document.

In the example illustrated in FIG. 7, the registration target execution record document (surgery record document) is registered as an execution record document on which execution of a medical act having a medical act type such as “surgery recording” as the attribute thereof is recorded, and is also registered as an execution record document on which execution of a medical act having a medical act type such as “surgery part checking” as the attribute thereof is recorded. In other words, the surgery record document is registered as a substitute execution record document of a surgery part check document.

In the document management table, a medical act having a medical act type such as “surgery recording” as the attribute thereof is correlated with an execution record document having an execution record document type such as a “surgery record document” as the attribute thereof. Consequently, the execution record document which has the execution record document type such as a “surgery record document” as the attribute thereof and in which data or a paper sheet as the entity thereof exists is registered (entity-registered) in the medical information management system as an entity registered document. Data as the entity of the execution record document is registered in the document storage portion 18.

In the document management table, a medical act having a medical act type such as “surgery part checking” as the attribute thereof, an execution record document having an execution record document type such as a “surgery part check document” as the attribute thereof, and a substitute execution record document having a substitute execution record document type such as a “surgery recording document” as the attribute thereof are correlated with each other. Consequently, the execution record document which has the execution record document type such as a “surgery part check document” as the attribute thereof and in which data or a paper sheet as the entity thereof does not exist is replaced with the substitute execution record document having the substitute execution record document type such as a “surgery record document” as the attribute thereof, and is deemed to be registered in the medical information management system as a deemed registered document.

Hereinafter, candidates of an execution record document type displayed in the execution record document type selection field 56 will be described in detail. One or plural execution record document types correlated with (having relevance with a registration target execution record document) an execution record document type as the attribute of the registration target execution record document may be displayed in a list form as candidates of an execution record document type as the attribute of an deemed registered document in the execution record document type selection field 56.

For example, in the document type definition table, one or plural substitute execution record document types having relevance with an execution record document type are correlated with each execution record document type in advance. The presence or absence of the relevance is predefined on the basis of, for example, the actual history or statistical materials of medical act execution records.

For example, it is assumed that it is generally admitted that both of execution of a medical act A having, as the attribute thereof, a medical act type A (for example, surgery recording) correlated in advance with an execution record document type A (for example, a surgery record document) as the attribute of an execution record document A and execution of a medical act B having, as the attribute thereof, a medical act type B (for example, surgery part checking) which is different from the medical act type A are recorded on the execution record document A. In this case, the medical act type B is admitted to be a medical act type having relevance with the medical act type A, and the execution record document type B correlated in advance with the medical act type B is admitted in advance to be an execution record document type having relevance with the execution record document type A. In other words, the execution record document type B is an execution record document type which can be replaced with the execution record document type A, and the execution record document B is an execution record document which can be replaced with the execution record document A. In other words, the execution record document type A is an execution record document type which can be substituted for the execution record document type B, and the execution record document A is an execution record document type which can be substituted for the execution record document B.

For example, in a case where a frequency at which execution of the medical act B is recorded is equal to or more than a predefined threshold value on the basis of the history of execution records, the medical act B is admitted to be a medical act having relevance with the medical act A, and the execution record document B is admitted to be an execution record document having relevance with the execution record document A. In this case, in the document type definition table, the execution record document type A is correlated in advance with the execution record document type B as a substitute execution record document type. In a case where an execution record document having the execution record document type A as the attribute thereof is registered, the execution record document type B having relevance with the execution record document type A is displayed as a candidate in the execution record document type selection field 56. As mentioned above, since candidates of an execution record document type having relevance with an execution record document type as the attribute of a registration target execution record document are displayed, a worker may easily select a correlated execution record document type compared with a case where all execution record document types are displayed as candidates. The display control portion 30 may display both the execution record document type having relevance and an execution record document type not having relevance in the execution record document type selection field 56, and may make a display aspect of the execution record document type having relevance and a display aspect of the execution record document type not having relevance different from each other. For example, the display control portion 30 may light information indicating the execution record document type having relevance.

In the document type definition table, one or plural execution record document types which are hard to replace may be correlated with each execution record document type in advance. In this case, in a case where an execution record document having, as the attribute thereof, an execution record document type which is hard to replace is registered, an execution record document type correlated with the execution record document type which is hard to replace is not displayed in the execution record document type selection field 56.

The execution record document type which is hard to replace is, for example, an execution record document type not having relevance with an execution record document type correlated in advance with the execution record document type which is hard to replace. In the above-described example, in a case where a frequency at which execution of the medical act B is recorded on the execution record document A is less than a threshold value, the medical act B is admitted in advance to be a medical act not having relevance with the medical act A, and the execution record document type B is admitted in advance to be an execution record document type not having relevance with the execution record document type A. In this case, in the document type definition table, the execution record document type A which is hard to replace is correlated with the medical act type B and the execution record document type B in advance.

As another example, an execution record document type which is hard to replace is an execution record document type which is inhibited from being used as a substitute document type of an execution record document type correlated in advance with the execution record document type which is hard to replace.

In a case where an execution record document having, the attribute thereof, an execution record document type which is hard to replace is registered, an execution record document type correlated with the execution record document type which is hard to replace may not be displayed in the execution record document type selection field 56 illustrated in FIG. 7, and may be displayed in an unselectable manner.

The document management unit 26 may extract a portion of a registration target execution record document on which execution of a medical act having, as the attribute thereof, a medical act type which is different from a medical act type correlated in advance with an execution record document type as the attribute of the execution record document is recorded, and may estimate the differing medical act type as the attribute of the medical act recorded on the portion by applying language analysis on text described on the portion. In this case, the display control portion 30 may display an execution record document type correlated in advance with the differing medical act type in the execution record document type selection field 56 as a candidate. The document management unit 26 may automatically perform the extraction, and may extract a portion designated by a worker. Hereinafter, this will be described in detail with reference to FIG. 7.

For example, in a case where the worker designates a portion (for example, a region 60) on which execution of a medical act having a differing medical act type as the attribute thereof is recorded in the registration target execution record document displayed in the document display region 52, the document management unit 26 extracts a portion corresponding to the region 60, and applies language analysis to text described in the region 60 so as to estimate a medical act type (for example, surgery part checking) as the attribute of the medical act recorded on the portion. In this case, the display control portion 30 displays an execution record document type (for example, a surgery part check document) correlated with the estimated medical act type in advance in the execution record document type selection field 56 as a candidate. The document management unit 26 may automatically detect the region 60 so as to estimate a differing medical act type by applying language analysis to the registration target execution record document.

The document management unit 26 may automatically correlate an execution record document type correlated in advance with a medical act type estimated as a result of the language analysis with the registration target execution record document as a substitute execution record document, and may automatically deem an execution record document having the execution record document type as the attribute thereof to be registered.

A medical act selection field may be displayed on the registration screen 50 instead of the execution record document type selection field 56 being displayed. A list of medical act candidates is displayed in the medical act selection field. In this case, if a worker selects a medical act from the list of the candidates displayed in the medical act selection field, the document management unit 26 correlates the selected medical act with a registration target execution record document, and deems an execution record document having, as the attribute thereof, an execution record document type correlated in advance with a medical act type as the attribute of the selected medical act, to be registered in the medical information management system. The registration target execution record document is registered as a substitute execution record document. The medical act selected by the worker, the execution record document deemed to be registered, and the substitute execution record document are correlated with each other in management information of the execution record document deemed to be registered.

In the example illustrated in FIG. 7, when an execution record document is registered, other execution record documents or other medical acts are correlated with the registration target execution record document, and a deemed registered document is deemed to be registered. Of course, the correlation may be performed at timings other than the time at which the execution record document is registered. For example, in a case where an entity registered document is edited or referred to, another execution record document or another medical act may be correlated with the entity registered document so that another execution record document is deemed to be registered as deemed registered document.

Hereinafter, a detailed description will be made of display of a registered execution record document.

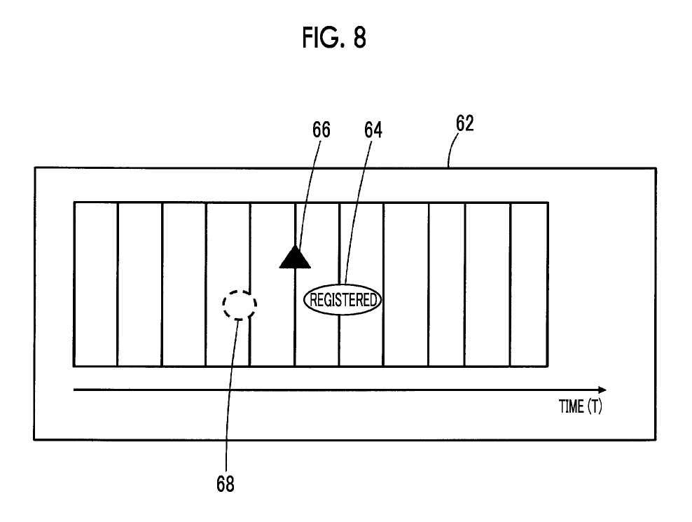

FIG. 8 illustrates an example of a medical act execution progress screen. An execution progress screen 62 is a screen indicating the progress of execution of a medical act, that is, a screen indicating the progress of creation of an execution record document on which execution of the medical act is recorded, and is created on the basis of management information of the execution record document for each patient. For example, if the worker accesses the medical information management apparatus 10 by using the terminal apparatus 12, and designates a patient ID and also makes a request for display of an execution progress screen, the display control portion 30 creates data of the execution progress screen 62 on the basis of management information of an execution record document correlated with the designated patient ID. The data of the execution progress screen 62 is transmitted from the medical information management apparatus 10 to the terminal apparatus 12, and the execution progress screen 62 is displayed on the UI unit 38 of the terminal apparatus 12. Of course, the execution progress screen 62 may be displayed on the UI unit 32 of the medical information management apparatus 10. Hereinafter, it is assumed that the execution progress screen 62 is displayed on the UI unit 38 of the terminal apparatus 12.

Images (for example, document marks 64, 66 and 68) correlated with the patient ID designated by the worker and associated with execution record documents registered in the document management table are displayed in a time series according to the date and time at which the execution record document is created on the execution progress screen 62. In this case, an image associated with an execution record document whose entity is registered and an execution record document (deemed registered document) deemed to be registered are displayed to be differentiated from each other. In the example illustrated in FIG. 8, a transverse axis expresses time indicating the creation date and time, and the respective document marks are displayed in a time series according to the creation date and time of the execution record documents associated with the document marks.

The document marks 64 and 66 are marks associated with execution record documents whose entities are registered, that is, marks associated with execution record documents in which data or a paper sheet as the entity thereof exists and which are registered in the medical information management system. The document mark 68 is a mark associated with a deemed registered document (an execution record document deemed to be registered), that is, a mark associated with an execution record document in which data or a paper sheet as the entity thereof does not exist and which is replaced with a substitute execution record document. The display control portion 30 may make a display aspect of the mark associated with the execution record document whose entity is registered and a display aspect of the mark associated with the execution record document deemed to be registered different from each other. The display control portion 30 may make display colors or shapes different from each other between a display aspect of the mark associated with the execution record document whose entity is registered and a display aspect of the mark associated with the execution record document deemed to be registered, and may make lighting or linking aspects from each other therebetween. The display control portion 30 may make display aspects of the marks different from each other according to execution record document types.

If a document mark is designated by the worker, the display control portion 30 specifies an execution record document associated with the designated document mark in the document management table, and controls display of the execution record document. For example, the execution record document associated with the designated document mark is displayed on the UI unit 38 of the terminal apparatus 12. In a case where the document mark 64 associated with the execution record document whose entity is registered is designated by the worker, the display control portion 30 displays the execution record document whose entity is registered and which is associated with the document mark 64 on the terminal apparatus 12. In a case where the document mark 68 associated with the execution record document (deemed registered document) deemed to be registered is designated by the worker, the display control portion 30 displays a substitute execution record document correlated with the deemed registered document associated with the document mark 68 on the terminal apparatus 12. Of course, the execution record document may be displayed on the UI unit 32 of the medical information management apparatus 10.

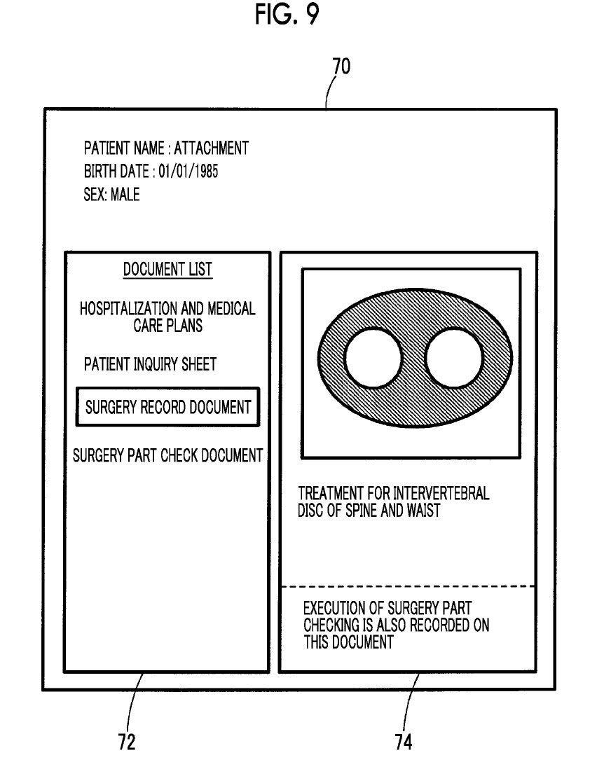

Hereinafter, with reference to FIG. 9, a description will be made of a display example of an execution record document whose entity is registered. FIG. 9 illustrates an example of a document display screen on which an execution record document is displayed.

For example, if the worker accesses the medical information management apparatus 10 by using the terminal apparatus 12, and designates a patient ID and also makes a request for display of an execution record document, the display control portion 30 creates data of a document display screen 70. The data of the document display screen 70 is transmitted from the medical information management apparatus 10 to the terminal apparatus 12, and the document display screen 70 is displayed on the UI unit 38 of the terminal apparatus 12. Of course, the document display screen 70 may be displayed on the UI unit 32 of the medical information management apparatus 10. Hereinafter, it is assumed that the document display screen 70 is displayed on the UI unit 38 of the terminal apparatus 12.

As illustrated in FIG. 9, the document display screen 70 includes a list display region 72 and a document display region 74.

A list of execution record documents correlated with the patient ID designated by the worker and registered in the medical information management system is displayed in the list display region 72. The display control portion 30 extracts one or plural execution record documents correlated with the designated patient ID from an execution record document group registered in the document management table, and displays information (for example, a document name or an execution record document type) indicating the extracted one or plural execution record documents in the list display region 72. In this case, the display control portion 30 extracts both of an execution record document whose entity is registered and an execution record document (deemed registered document) deemed to be registered, and displays information indicating the documents in the list display region 72.

In the example illustrated in FIG. 9, an execution record document having an execution record document type such as “hospitalization and medical care plans” as the attribute thereof, an execution record document having an execution record document type such as a “patient inquiry sheet” as the attribute thereof, an execution record document having an execution record document type such as a “surgery record document” as the attribute thereof, and an execution record document having an execution record document type such as a “surgery part check document” as the attribute thereof are registered in the medical information management system as documents regarding the designated patient, and information indicating the documents is displayed in the list display region 72. Each execution record document is an entity registered document or a deemed registered document.

If an execution record document is designated by the worker from the list of the execution record documents displayed in the list display region 72, the display control portion 30 displays the designated execution record document in the document display region 74. In the example illustrated in FIG. 9, the execution record document having the execution record document type such as a “surgery record document” as the attribute thereof is designated from the list of the execution record documents. In this case, the display control portion 30 determines whether or not a substitute execution record document is correlated with the execution record document having the execution record document type such as a “surgery record document” as the attribute thereof in the document management table. In a case where a substitute execution record document is not correlated with the execution record document having the execution record document type such as a “surgery record document” as the attribute thereof, the execution record document having the execution record document type such as a “surgery record document” as the attribute thereof corresponds to an execution record document whose entity is registered. In this case, the display control portion 30 acquires data as the entity of the execution record document having the execution record document type such as a “surgery record document” as the attribute thereof from the document storage portion 18, and displays the entity of the execution record document in the document display region 74.

In the example illustrated in FIG. 9, the execution record document having the execution record document type such as a “surgery record document” as the attribute thereof is an execution record document whose entity is recorded, and the entity (surgery record document) of the execution record document is displayed in the document display region 74. The execution record document having the execution record document type such as a “surgery record document” as the attribute thereof is correlated with an execution record document (deemed registered document) deemed to be registered and is also registered as a substitute execution record document. In this case, the display control portion 30 displays information indicating the deemed registered document or information indicating a medical act correlated with the deemed registered document in the document display region 74. In the example illustrated in FIG. 9, execution of a medical act having a medical act type such as “surgery part checking” as the attribute thereof is recorded on the execution record document having the execution record document type such as a “surgery record document” as the attribute thereof, and the execution record document having the execution record document type such as a “surgery record document” as the attribute thereof is also registered as a substitute execution record document of an execution record document having an execution record document type such as a “surgery part check document” as the attribute thereof. Therefore, information indicating that execution of surgery part checking is also recorded on the surgery record document is displayed in the document display region 74.

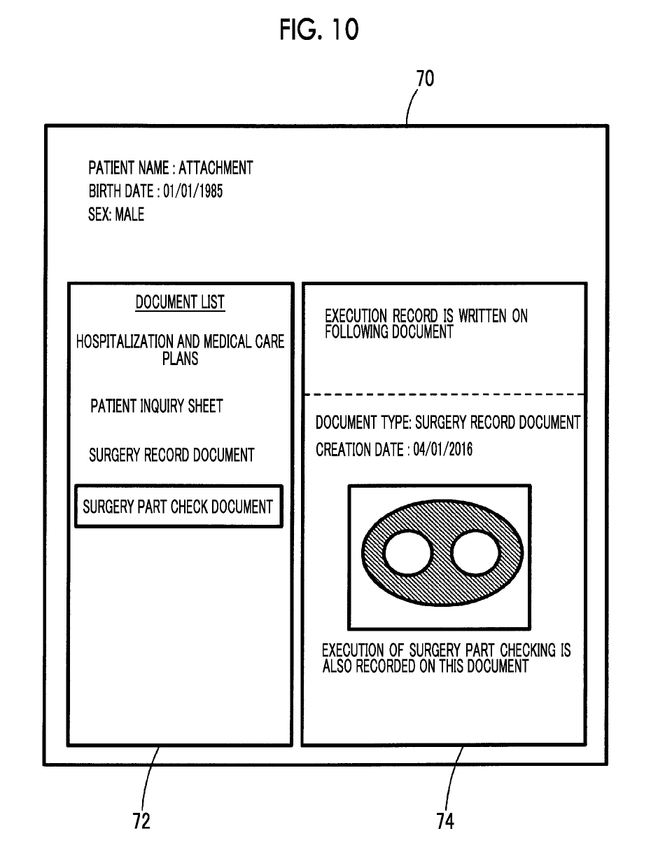

Hereinafter, with reference to FIG. 10, a description will be made of a display example of a substitute execution record document. FIG. 10 illustrates an example of a document display screen on which an execution record document is displayed.

In the example illustrated in FIG. 10, an execution record document having an execution record document type such as a “surgery part check document” as the attribute thereof is designated from the list of the execution record documents displayed in the list display region 72. In this case, the display control portion 30 determines whether or not a substitute execution record document is correlated with the execution record document having the execution record document type such as a “surgery part check document” as the attribute thereof in the document management table. In a case where a substitute execution record document is correlated with the execution record document having the execution record document type such as a “surgery part check document” as the attribute thereof, the execution record document having the execution record document type such as a “surgery part check document” as the attribute thereof corresponds to an execution record document (deemed registered document) deemed to be registered. In this case, the display control portion 30 specifies a substitute execution record document correlated with the execution record document having the execution record document type such as a “surgery part check document” as the attribute thereof in the document management table, acquires data as the entity of the substitute execution record document from the document storage portion 18, and displays the entity of the substitute execution record document in the document display region 74.

In the example illustrated in FIG. 10, the execution record document having the execution record document type such as a “surgery part check document” as the attribute thereof is an execution record document (deemed registered document) deemed to be registered, and is correlated with the substitute execution record document having a substitute execution record document type such as a “surgery record document” as the attribute thereof. In this case, the entity (surgery record document) of the substitute execution record document is displayed in the document display region 74. Consequently, the entity (surgery record document) of the execution record document on which execution of a medical act having a medical act type such as “surgery part checking” as the attribute thereof is actually recorded is displayed in the document display region 74.

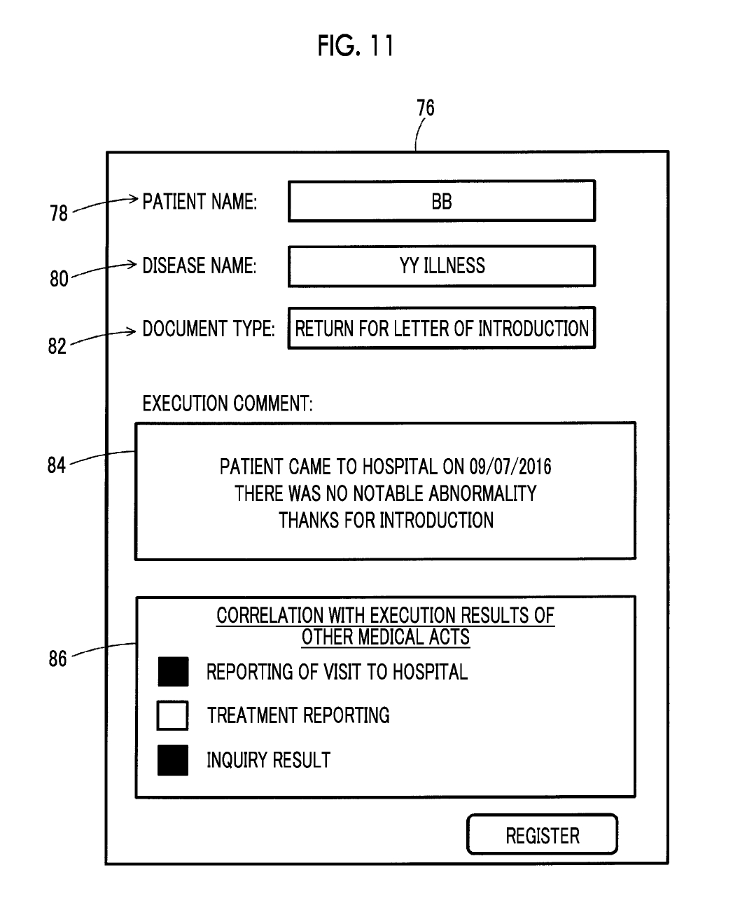

Hereinafter, with reference to FIG. 11, a description will be made of another example of a registration screen for an execution record document. FIG. 11 illustrates an example of a registration screen for an execution record document.

For example, it is assumed that a worker performs an operation of registering an execution record document by using the terminal apparatus 12. In this case, if the worker accesses the medical information management apparatus 10 by using the terminal apparatus 12, and makes a request for registering an execution record document, data of a registration screen 76 is transmitted from the medical information management apparatus 10 to the terminal apparatus 12, and thus the registration screen 76 is displayed on the UI unit 38 of the terminal apparatus 12. Of course, the worker may perform an operation of registering an execution record document by using the medical information management apparatus 10. In this case, the registration screen 76 is displayed on the UI unit 32 of the medical information management apparatus 10. Hereinafter, it is assumed that a registration operation is performed by using the terminal apparatus 12.

The registration screen 76 includes, for example, a patient name entry field 78, a disease name entry field 80, a document type entry field 82, a comment entry field 84, and a medical act selection field 86. A patient name is entered to the patient name entry field 78. A disease name is entered to the disease name entry field 80. An execution record document type as the attribute of a registration target execution record document is entered to the document type entry field 82. A comment described in data of the registration target execution record document is entered to the comment entry field 84. A list of candidates of a medical act which has, as the attribute thereof, a medical act type which is different from a medical act type correlated in advance with an execution record document type as the attribute of the registration target execution record document and is correlated with the registration target execution record document is displayed in the medical act selection field 86.

The document management unit 26 registers the registration target execution record document in the medical information management system as an execution record document having the execution record document type entered to the document type entry field 82 as the attribute thereof, correlates a medical act selected from the list of the candidates displayed in the medical act selection field 86 with the registration target execution record document, and deems an execution record document having, as the attribute thereof, an execution record document type correlated in advance with a medical act type as the attribute of the selected medical act to be registered. In this case, the registration target execution record document is registered as an execution record document having an execution record document type thereof as the attribute thereof, and is also registered as a substitute execution record document of an execution record document having, as the attribute thereof, an execution record document type correlated in advance with a medical act type as the attribute of the medical act selected from the list.

All medical acts may be displayed in the medical act selection field 86, and a predefined medical act may be displayed therein. For example, in the document type definition table, a medical act with which an execution record document type as the attribute of a registration target execution record document is correlated as a substitute execution record document type may be displayed in the medical act selection field 86. As another example, a medical act selected on the basis of the actual history or statistical materials of medical act execution records may be displayed in the medical act selection field 86.

In the example illustrated in FIG. 11, an execution record document type such as “return for the letter of introduction” is designated as the attribute of the registration target execution record document. As candidates of other medical acts correlated with the registration target execution record document, pieces of information respectively indicating “reporting of visit to the hospital of a patient”, “reporting of treatment”, and an “inquiry result” are displayed. For example, in the document type definition table, in a case where an execution record document type such as “return for a letter of introduction” is correlated with a medical act type such as “reporting of visit to the hospital of a patient” as a substitute execution record document type, a medical act such as “reporting of visit to the hospital of a patient” is displayed as a candidate in the medical act selection field 86 of the registration screen 76 for registering an execution record document having the execution record document type such as “return for a letter of introduction” as the attribute thereof. This is also the same for the “reporting of treatment” and the “inquiry result”.

For example, in a case where a worker checks the content of a comment entered to the comment entry field 84, and execution of a medical act having, as the attribute thereof, a medical act type which is different from a medical act type correlated in advance with an execution record document type as the attribute of the execution record document is recorded in the comment entry field 84, the worker selects a medical act having the differing medical act type as the attribute thereof from the list displayed in the medical act selection field 86. In the example illustrated in FIG. 11, a comment on visit to the hospital (a comment such as “visit to the hospital”) and a comment on an inquiry result (a comment such as “no noticeable abnormality”) are entered to the comment entry field 84, and, in the medical act selection field 86, a medical act such as “reporting of visit to the hospital of a patient” corresponding to the comment on visit to the hospital and a medical act such as an “inquiry result” corresponding to the inquiry result are selected by the worker.

In a case where a registration button image is displayed on the registration screen 76, and the worker presses the registration button image, the document management unit 26 adds management information of the registration target execution record document to the document management table illustrated in FIG. 5. The document management unit 26 stores data of the registration target execution record document in the document storage portion 18. Consequently, the registration target execution record document (an execution record document in which data as the entity thereof exists) is registered (entity-registered) in the medical information management system.

In a case where a medical act is selected from the list of the candidates displayed in the medical act selection field 86, the document management unit 26 correlates the selected medical act with the registration target execution record document as a substitute execution record document, and deems an execution record document having, as the attribute thereof, an execution record document type correlated in advance with a medical act type as the attribute of the selected medical act to be registered in the medical information management system as a deemed registered document. In other words, the document management unit 26 causes information indicating the substitute execution record document to be included in management information of the deemed registered target execution record document, and adds the management information to the document management table. Specifically, a medical act selected from the list of the candidates displayed in the medical act selection field 86, an execution record document having, the attribute thereof, an execution record document type correlated in advance with a medical act type as the attribute of the medical act, and a substitute execution record document are correlated with each other, and are added to the document management table as management information. Consequently, the execution record document having, as the attribute thereof, the execution record document type correlated in advance with the medical act type as the attribute of the medical act selected from the list of the candidates displayed in the medical act selection field 86 is deemed to be registered in the medical information management system as deemed registered document.

In the example illustrated in FIG. 11, the registration target execution record document (a letter of return for a letter of introduction) is registered as an execution record document having an execution record document type such as “return for a letter of introduction”, and is also registered as an execution record document on which execution of medical acts such as “reporting of visit to the hospital of a patient” and an “inquiry result” is recorded. In other words, the letter of return for a letter of introduction is also registered as substitute execution record documents of a report of visit to the hospital of a patient and an inquiry result document.

In the document management table, a medical act having a medical act type such as “return for a letter of introduction” as the attribute thereof is correlated with an execution record document having an execution record document type such as a “letter of return for a letter of introduction” as the attribute thereof. Consequently, an execution record document which has an execution record document type such as a “letter of return for a letter of introduction” as the attribute thereof and in which data as the entity thereof exists is registered (entity-registered) in the medical information management system as an entity registered document. Data as the entity of the execution record document is stored in the document storage portion 18.

In the document management table, a medical act such as “reporting of visit to the hospital of a patient”, an execution record document having an execution record document type such as a “report of visit to the hospital of a patient” as the attribute thereof, and an execution record document having a substitute execution record document type such as a “letter of return for a letter of introduction” as the attribute thereof are correlated with each other. Consequently, an execution record document which has an execution record document type such as a “report of visit to the hospital of a patient” as the attribute thereof and in which data or a paper sheet as the entity thereof does not exist is replaced with a substitute execution record document having a substitute execution record document type such as a “letter of return for a letter of introduction” as the attribute thereof, and is deemed to be registered in the medical information management system as a deemed registered document. This is also the same fora medical act such as an “inquiry result”.

Hereinafter, candidates of a medical act displayed in the medical act selection field 86 will be described in detail. One or plural medical acts having, as the attribute(s) thereof, one or plural medical act types correlated with an execution record document type (having relevance with the execution record document type) as the attribute of the registration target execution record document may be displayed in a list form as candidates of an execution record document type as the attribute of a deemed registered document in the medical act selection field 86.

For example, in the document type definition table, one or plural medical act types having relevance with an execution record document type are correlated with each execution record document type in advance. The presence or absence of the relevance is predefined on the basis of, for example, the actual history or statistical materials of medical act execution records. In the example described with reference to FIG. 7, in the document type definition table, both of the medical act type A and the medical act type B are correlated with the execution record document type A, and the medical act B having the medical act type B as the attribute thereof is displayed in the medical act selection field 86 when the execution record document A having the execution record document type A as the attribute thereof is registered. Consequently, a worker may easily select a correlated medical act compared with a case where all medical acts are displayed as candidates.

The document management unit 26 may estimate a medical act recorded in the comment entry field 84 by applying language analysis to a comment entered to the comment entry field 84. In this case, the display control portion 30 displays the estimated medical act in the medical act selection field 86 as a candidate. In the example illustrated in FIG. 11, since the comment on visit to the hospital and the comment on an inquiry result are recorded in the comment entry field 84, a medical act such as “reporting of visit to the hospital of a patient” and a medical act such as an “inquiry result” are displayed in the medical act selection field 86 as results of the language analysis on the comments.

The document management unit 26 may automatically correlate a medical act estimated as a result of the language analysis with the registration target execution record document as a substitute execution record document, and may automatically deem an execution record document having, as the attribute thereof, an execution record document type correlated in advance with a medical act type as the attribute of the medical act to be registered.

An entity registered document may be correlated with a medical act having, as the attribute thereof, a medical act type which is different from a medical act type correlated in advance with an execution record document type as the attribute of the entity registered document at timings other than the time at which an execution record document is registered. For example, in a case where an entity registered document is edited or referred to, the entity registered document may be correlated with a medical act having the differing medical act type as the attribute thereof. Also when an electronized execution record document is registered, an entity registered document may be correlated with a medical act having a differing medical act type as the attribute thereof through the same operation as the above-described operation during registration.

As mentioned above, according to the present exemplary embodiment, in a case where execution of a medical act is recorded on a substitute execution record document, the medical act is correlated with the substitute execution record document, and an execution record document having, as the attribute thereof, an execution record document type correlated in advance with a medical act type as the attribute of the medical act is deemed to be registered. Consequently, a state is prevented in which a document on which execution of the medical act is recorded does not exist as an entity.

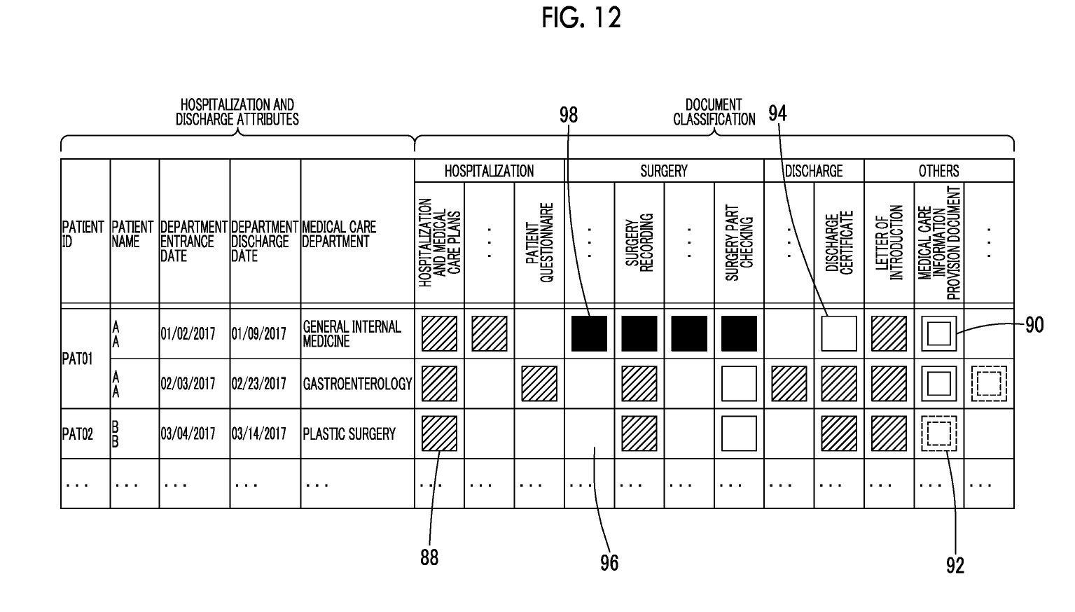

Hereinafter, with reference to FIG. 12, a description will be made of a screen (hereinafter, referred to as a “registration situation screen”) indicating a registration situation of an execution record document. FIG. 12 illustrates an example of a registration situation screen.

In this case, if the worker accesses the medical information management apparatus 10 by using the terminal apparatus 12, and makes a request for display of a document registration situation, data of a registration situation screen is transmitted from the medical information management apparatus 10 to the terminal apparatus 12, and is displayed on the UI unit 38 of the terminal apparatus 12. Of course, the registration situation screen may be displayed on the UI unit 32 of the medical information management apparatus 10. The data of the registration situation screen is created by, for example, the display control portion 30 of the medical information management apparatus 10. The registration situation screen is displayed, for example, when a medical audit is performed, and the audit is performed on the basis of information displayed on the registration situation screen. The medical information management apparatus 10 functions as a medical audit apparatus during an audit.

The registration situation screen includes, for example, a hospitalization and discharge attribute display region and a document classification display region.

In the hospitalization and discharge attribute display region, for example, a patient ID, information indicating a patient name, information indicating the department entrance date (the date on which a patient enters a specific medical care department), information indicating the department discharge date (the date on which a patient is discharged from the specific medical care department), and information indicating a medical care department used are displayed to be correlated with each other for each patient.

Information indicating whether or not each execution record document is registered is displayed for each patient in the document classification display region. Classification of execution record document groups is defined, and execution record documents are classified into, for example, an execution record document group regarding hospitalization, an execution record document group regarding surgery, and an execution record document group regarding discharge, or other execution record document groups. For example, the execution record document group regarding hospitalization includes “hospitalization and discharge medical care plans”, the execution record document group regarding surgery includes a “surgery record document”, the execution record document group regarding discharge includes a “discharge certificate”, and the other execution record document groups include a “letter of introduction”.

For example, an image indicating the presence or absence of registration is displayed as the information indicating the presence or absence of registration. For example, a registered image is displayed in a display field corresponding to an execution record document (entity registered document) which is not deemed to be registered and whose entity is registered. A deemed registered image is displayed in a display field corresponding to an execution record document (deemed registered document) deemed to be registered. An unregistered image is displayed in a display field corresponding to an execution record document which is not registered. Each image is created by, for example, the display control portion 30 of the medical information management apparatus 10.

The presence or absence of registration of an execution record document is determined on the basis of management information (document management table) stored in the management information storage portion 22.

In the document management table, an execution record document not correlated with a substitute execution record document is an execution record document (entity registered document) which is not deemed to be registered and whose entity is registered. Therefore, a registered image 88 is displayed in a display field corresponding to the execution record document. An image having the same shape as that of the registered image 88 is a registered image. For example, a registered image is displayed in a display field corresponding to “hospitalization and medical care plans” for a “general internal medicine” of a patient name “AA”. This indicates that the “hospitalization and medical care plans” are not deemed to be registered and are entity-registered.

In the document management table, an execution record document correlated with a substitute execution record document is replaced with the substitute execution record document, and is a deemed registered document which is deemed to be registered. Therefore, a deemed registered image 90 or a deemed registered image 92 is displayed in a display field corresponding to the execution record document.

The deemed registered image 90 is an image indicating an execution record document (deemed registered document) which is deemed to be registered through a manual operation. For example, in a case where the worker selects an execution record document type from the list of the execution record document type candidates displayed in the execution record document type selection field 56 illustrated in FIG. 7, an execution record document (deemed registered document) having the selected execution record document type as the attribute thereof through a manual operation. In a case where the worker selects a medical act from the list of the medical act candidates displayed in the medical act selection field 86 illustrated in FIG. 11, an execution record document (deemed registered document) having, as the attribute thereof, an execution record document type correlated in advance with a medical act type as the attribute of the selected medical act is deemed to be registered through a manual operation. The deemed registered image 90 is an image indicating the deemed registered document which is deemed to be registered through a manual operation in the above-described way. An image having the same shape as that of the deemed registered image 90 is an image indicating a deemed registered document which is deemed to be registered through a manual operation. For example, the deemed registered image 90 is displayed in a display field corresponding to a “medical care information provision document” for a “general internal medicine” of the patient name “AA”. This indicates that the “medical care information provision document” is deemed to be registered through a manual operation.

The deemed registered image 92 is an image indicating an execution record document (deemed registered document) which is automatically deemed to be registered. For example, the document management unit 26 automatically correlates a medical act estimated by applying language analysis to a substitute execution record document with a substitute execution record document, and thus an execution record document (deemed registered document) having, as the attribute thereof, an execution record document type correlated in advance with a medical act type as the attribute of the medical act is deemed to be registered. The deemed registered image 92 is an image indicating the deemed registered document which is automatically deemed to be registered in the above-described way. An image having the same shape as that of the deemed registered image 92 is an image indicating a deemed registered document which is deemed to be registered through a manual operation. For example, the deemed registered image 92 is displayed in a display field corresponding to a “medical care information provision document” for “plastic surgery” of the patient name “BB”. This indicates that the “medical care information provision document” is automatically deemed to be registered.

Of course, an image indicating deemed registration may be displayed without differentiating manually deemed registration and automatically deemed registration from each other.

An execution record document not registered in the document management table is an execution record document which is not registered. Therefore, an unregistered image 94 is displayed in a display field corresponding to the execution record document. An image having the same shape as that of the unregistered image 94 is also an image indicating non-registration. For example, the unregistered image 94 is displayed in a display field corresponding to a “discharge certificate” for a “general internal medicine” of the patient name “AA”. This indicates that the “discharge certificate” is not registered. The unregistered image 94 is an image indicating that an execution record document which is required to be registered is not registered. In the above-described example, the “discharge certificate” required to be registered is not registered.

A blank portion 96 indicates non-registration. For example, a display field corresponding to a “patient QUESTIONNAIRE” for a “general internal medicine” of the patient name “AA” is blank. This indicates that the “patient QUESTIONNAIRE” is not registered. The blank portion 96 indicates that an execution record document which is selectively registered is not registered. In the above-described example, the “patient QUESTIONNAIRE” which is selectively registered is not registered.

Of course, an image indicating non-registration may be displayed without differentiating an execution record document required to be registered and an execution record document selectively registered from each other.

A non-management image 98 is an image indicating an execution record document which is not scheduled to be registered. For example, an execution record document regarding surgery is not scheduled registered for a patient not scheduled to undergo a surgical operation, and thus the non-management image 98 is displayed in a display field corresponding to such an execution record document. An image having the same shape as that of the non-management image 98 is also an image indicating an execution record document not scheduled to be registered.

As mentioned above, a registration situation of each execution record document is presented. For example, during an audit, an auditor easily determines a registration situation of an execution record document compared with a case where a registration situation is not presented. Since a registered image and a deemed registered image are displayed to be differentiated from each other, it becomes easier to determine whether or not an execution record document is a deemed registered document than in a case where the images are displayed without being differentiated from each other.

In the above-described embodiment and modification examples, data of an execution record document corresponds to, for example, a single document file, but this is only an example, and data of an execution record document may be data including plural document files, and may be information provided from an electronic medical chart system or the like.

Each of the medical information management apparatus 10 and the terminal apparatus 12 is only an example, and is implemented through cooperation between hardware and software. Specifically, each of the medical information management apparatus 10 and the terminal apparatus 12 includes one or plural processors such as a CPU (not illustrated). The one or plural processors read a program stored in a storage device (not illustrated) and execute the program, and thus a function of each unit of the medical information management apparatus 10 and the terminal apparatus 12 is realized. The program is stored in the storage device via a recording medium such as a CD or a DVD, or a communication path such as a network. As another example, each unit of the medical information management apparatus 10 and the terminal apparatus 12 may be implemented by a hardware resource such as a processor, an electronic circuit, or an application specific integrated circuit (ASIC). A device such as a memory may be used for the implementation. As still another example, each unit of the medical information management apparatus 10 and the terminal apparatus 12 may be implemented by, for example, a digital signal processor (DSP) or a field programmable gate array (FPGA).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a memory that stores a medical act type and an execution record document type correlated with the medical act type in advance; and
a holding unit that holds an execution record document which has, as an attribute thereof, a differing execution record document type which is different from the execution record document type correlated with the medical act type in advance and on which execution of a medical act having the medical act type as an attribute thereof is recorded, in correlation with the medical act.

2. The information processing apparatus according to claim 1,
wherein the memory stores one or a plurality of candidates of medical act types capable of being correlated with the differing execution record document type, and
wherein a medical act type of the medical act held to be correlated with the execution record document having the differing execution record document type as the attribute thereof is selected from among the one or plurality of candidates of medical act types.

3. The information processing apparatus according to claim 2,
wherein the medical act type correlated in advance is selectable as the medical act type correlated with the execution record document having the differing execution record document type as the attribute thereof.

4. The information processing apparatus according to claim 1,
wherein the memory stores one or a plurality of candidates of a medical act type as the attribute of a medical act capable of being correlated with the execution record document having the differing execution record document type as the attribute thereof, and
wherein the holding unit holds a medical act having, as the attribute thereof, a medical act type selected from among the one or plurality of candidates of medical act types in correlation with an execution record document having the differing execution record document type as the attribute thereof.

5. The information processing apparatus according to claim 1, further comprising:
a controller that displays an execution record document on a display.

6. The information processing apparatus according to claim 2, further comprising:
a controller that displays an execution record document on a display.

7. The information processing apparatus according to claim 3, further comprising:
a controller that displays an execution record document on a display.

8. The information processing apparatus according to claim 4, further comprising:
a controller that displays an execution record document on a display.

9. The information processing apparatus according to claim 5,
wherein the controller makes a display aspect of an execution record document having, as the attribute thereof, the execution record document type correlated with the medical act type in advance and a display aspect of the execution record document having, as the attribute thereof, the differing execution record document type correlated with the medical act different from each other.

10. The information processing apparatus according to claim 6,
wherein the controller makes a display aspect of an execution record document having, as the attribute thereof, the execution record document type correlated with the medical act type in advance and a display aspect of the execution record document having, as the attribute thereof, the differing execution record document type correlated with the medical act different from each other.

11. The information processing apparatus according to claim 7,
wherein the controller makes a display aspect of an execution record document having, as the attribute thereof, the execution record document type correlated with the medical act type in advance and a display aspect of the execution record document having, as the attribute thereof, the differing execution record document type correlated with the medical act different from each other.

12. The information processing apparatus according to claim 8,
wherein the controller makes a display aspect of an execution record document having, as the attribute thereof, the execution record document type correlated with the medical act type in advance and a display aspect of the execution record document having, as the attribute thereof, the differing execution record document type correlated with the medical act different from each other.

13. A medical audit apparatus comprising:
a memory that stores a medical act type and an execution record document type correlated with the medical act type in advance;
a holding unit that holds an execution record document which has, as an attribute thereof, a differing execution record document type which is different from the execution record document type correlated with the medical act type in advance and on which execution of a medical act having the medical act type as an attribute thereof is recorded, in correlation with the medical act; and
a controller that displays information regarding the existence or absence of an execution record document as information used for an audit on a display in a case where the audit of medical information is performed.

14. A non-transitory computer readable medium storing a program causing a computer to function as:
a storage controller that stores a medical act type and an execution record document type correlated with the medical act type in advance in a memory; and
a holding unit that holds an execution record document which has, as an attribute thereof, a differing execution record document type which is different from the execution record document type correlated with the medical act type in advance and on which execution of a medical act having the medical act type as an attribute thereof is recorded, in correlation with the medical act.
